(19) United States
(12) Patent Application Publication
(10) Pub. No.: US 2008/0046908 A1
(43) Pub. Date: Feb. 21, 2008

(54) Original glass plate, method of producing original glass plate, stamper for optical recording medium, and method of producing stamper

(75) Inventors: Yanlong Che, Odawara-shi (JP); Michihiro Shibata, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/889,492

(22) Filed: Aug. 14, 2007

(30) Foreign Application Priority Data
Aug. 18, 2006 (JP) 2006-223002

(51) Int. Cl. G11B 7/24; G11B 23/03

(52) U.S. Cl. 720/718

(57) ABSTRACT

A disc-shaped original glass plate for producing a stamper for roughening a substrate of an optical recording medium, containing a circular 21st area within a radius D1 from the center of the original glass plate, a circular 22nd area within a radius D2 (>D1) from the center, a ring-shaped 23rd area obtained by omitting the 21st area from the 22nd area, and a ring-shaped 24th area obtained by omitting the 22nd area from an entire the major surface of the glass plate, wherein the 21st and 24th areas are lustrous, and the 23rd area is roughened. The surface roughness of the 23rd area is such that the arithmetic average roughness Ra is 0.05 to 2.0 μm and the ten-point average roughness Rz is 0.1 to 5.0 μm.

### BACKGROUND OF THE INVENTION

1. Field of the Invention

The present invention relates to an original glass plate, a method of producing an original glass plate, a stamper for an optical recording medium and a method of producing a stamper for an optical recording medium, particularly an original glass plate for producing an optical recording medium containing a substrate having an entirely or partly roughened major surface, a method of producing such an original glass plate, a stamper for such an optical recording medium, and a method of producing such a stamper.

2. Description of the Related Art

In several known optical recording media such as CD-Rs and DVD-Rs, electronic information is recorded on a recording surface, and a label is attached to the reverse surface. Visible information of the contents of the electronic information, such as a song title of music data or a title of recorded data, is printed on the label, and the reverse surface is called a label surface.

Such optical recording media are produced by printing a title or the like on a circular label sheet using a printer, and by attaching the label sheet to the label surface.

Thus, the printer is needed in addition to a disc drive for producing the optical recording media. Data is recorded by the disc drive on the recording surface of the optical recording medium, the medium is removed from the disc drive, and then the label sheet printed by the printer is attached thereto. Therefore, complicated operations are required for producing the optical recording media.

Optical recording media with label surfaces, on which information can be displayed by changing the contrast using laser markers, have been proposed in Japanese Laid-Open Patent Publication No. 11-66617, etc. In the optical recording media, by using only an optical recording medium drive, information can be recorded on the recording surface and a visible image can be recorded on the label surface. Thus, additional printers are not needed, and also the complicated operations of attaching the label sheet are not required.

In optical recording media such as DVD-Rs, a substrate for a recording layer may have regular grooves, and also another substrate for a visible image recording layer may have such regular grooves. In this case, the grooves on the other substrate act as a diffraction grating for external lights to cause strong interference, thereby resulting in poor visibility of a recorded visible image.

The visibility can be improved by roughening the substrate. However, in this case, a light incident to the label surface is hardly scattered and the label surface has a viewing directivity. Thus, the image is not visible from one direction, though highly visible from another direction.

Accordingly, there has been a demand for further improving the visibility of an image recorded on the label surface.

Several roughening methods are described in Japanese Laid-Open Patent Publication Nos. 2001-33629 and 2004-70995. However, the methods are not for roughening the substrate but for roughening an outer circumference surface of an original glass plate or a stamper, and cannot be used for the substrate producing.

### SUMMARY OF THE INVENTION

In view of the above problem, an object of the present invention is to provide an original glass plate useful for producing an optical recording medium excellent in visibility of an image on a label surface, a method of producing an original glass plate and a stamper, and a method of producing an original glass plate, a stamper for an optical recording medium.

According to a first aspect of the present invention, there is provided a disc-shaped original glass plate for producing a stamper for roughening a substrate of an optical recording medium, comprising a circular first area within a radius D1 from the center of the original glass plate, a circular second area within a radius D2 (>D1) from the center, a ring-shaped third area obtained by omitting the first area from the second area, and a ring-shaped fourth area obtained by omitting the second area from an entire surface of the original glass plate, wherein the first area and the fourth area are lustrous, and the third area is roughened.

The original glass plate according to the first aspect can be used for producing a stamper. Further, an optical recording medium with excellent visibility of an image on the label surface can be produced by using the stamper.

In the first aspect, the surface roughness of the third area is preferably such that the arithmetic average roughness Ra is 0.05 to 2.0 μm and the ten-point average roughness Rz is 0.1 to 5.0 μm.

In the first aspect, the radius D2 of the second area is preferably equal to or smaller than the radius of the substrate, and is particularly preferably slightly smaller than the radius of the substrate.

Further, in the first aspect, the first area may be used for forming a pit forming site on the stamper, and the pit forming site may be used for forming a pre-pit on an inner portion of the substrate.

In the first aspect, the third area is preferably roughened by a blasting treatment, a grinding treatment, a shot-peening treatment, or an etching treatment. In this case, it is preferred that the original glass plate has a thickness of 50 to 65 mm to have a mechanical strength sufficient for the roughening treatments.

According to a second aspect of the present invention, there is provided a method of producing a disc-shaped original glass plate for producing a stamper for roughening a substrate of an optical recording medium, comprising the steps of: preparing a disc-shaped glass plate having at least a lustrous major surface comprising a circular first area within a radius D1 from the center of the glass plate, a circular second area within a radius D2 (>D1) from the center, a ring-shaped third area obtained by omitting the first area from the second area, and a ring-shaped fourth area obtained by omitting the second area from the entire major surface; masking the first area and the fourth area; and roughening the third unmasked area in the major surface of the glass plate to obtain the original glass plate.

The original glass plate according to the first aspect can be easily produced by the method according to the second aspect, and an optical recording medium excellent in the visibility of an image on the label surface can be produced with lower costs by using the method.

In the second aspect, the third unmasked area is preferably roughened by a blasting treatment, a grinding treatment, a shot-peening treatment, or an etching treatment.

According to a third aspect of the present invention, there is provided a stamper for roughening a substrate of an optical recording medium, comprising a circular first area within a radius D1 from the center of the stamper, a circular second area within a radius D2 (>D1) from the center, a ring-shaped third area obtained by omitting the first area from the second area, and a ring-shaped fourth area obtained by omitting the second area from an entire surface of the stamper, wherein the first area and the fourth area are lustrous, and the third area is roughened.

By using the stamper according to the third aspect, an optical recording medium excellent in the visibility of an image on the label surface can be produced.

In the third aspect, the surface roughness of the third area is preferably such that the ten-point average roughness Rz is 0.1 to 5.0 μm and the mean spacing of profile irregularities RSm is 10 to 500 μm. The image visibility can be largely improved when the third area has such a surface roughness.

In the third aspect, the radius D2 of the second area is preferably equal to or smaller than the radius of the substrate, and is particularly preferably slightly smaller than the radius of the substrate.

In the third aspect, the first area may have a pit forming site for forming a pre-pit on an inner portion of the substrate.

Further, in the third aspect, the stamper preferably has a thickness of 140 to 300 μm.

According to a fourth aspect of the present invention, there is provided a method of producing a stamper for roughening a substrate of an optical recording medium, comprising the steps of: preparing a disc-shaped original glass plate having at least a lustrous major surface comprising a circular first area within a radius D1 from the center of the original glass plate, a circular second area within a radius D2 (>D1) from the center, a ring-shaped third area obtained by omitting the first area from the second area, and a ring-shaped fourth area obtained by omitting the second area from the entire major surface; masking the first area and the fourth area; roughening the third area unmasked in the major surface of the original glass plate; and forming a metal layer on the major surface of the original glass plate to obtain an original stamper.

In the stamper for roughening the substrate of the optical recording medium, an area corresponding to the third area of the original glass plate is roughened.

The stamper according to the third aspect can be easily produced by the method according to the fourth aspect, and an optical recording medium excellent in the visibility of an image on the label surface can be produced with lower costs by using the method.

The method of the fourth aspect may further comprise the step of forming a resist mask on the first area of the original glass plate after the step of roughening the third area before the step of forming the metal layer. The resist mask is used for forming a pit forming site, and the pit forming site is used for forming a pre-pit on the optical recording medium. In the stamper for roughening the substrate of the optical recording medium, an area corresponding to the first area of the original glass plate has the pit forming site and an area corresponding to the third area of the original glass plate is roughened.

As described above, by using the original glass plate, the original glass plate producing method, the stamper, or the stamper producing method according to the present invention, the optical recording medium excellent in the visibility of an image on a label surface can be obtained.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a cross-sectional view partly showing an optical recording medium according to an embodiment of the present invention;

FIG. 2 is a plan showing an example of a major surface of a second substrate containing first to fourth areas;

FIG. 3 is a plan showing an optical recording medium of a modification example according to the embodiment;

FIG. 4 is an enlarged cross-sectional view showing a pre-pit region of the optical recording medium of FIG. 1;

FIG. 5 is a cross-sectional view partly showing a master stamper according to the embodiment;

FIG. 6 is a plan view showing an example of a major surface of the master stamper containing 11th to 14th areas;

FIG. 7 is a production process chart of a method according to the embodiment;

FIG. 8 is a cross-sectional view showing an original glass plate used in the method according to the embodiment;

FIG. 9 is a cross-sectional view showing masks formed on a major surface of the glass plate;

FIG. 10A is a cross-sectional view showing areas unmasked between the masks on the major surface of the glass plate, subjected to a roughening treatment;

FIG. 10B is an enlarged cross-sectional view showing a portion of the glass plate;

FIG. 11 is a plan showing an example of the major surface of the glass plate containing 21st to 24th areas;

FIG. 12A is a cross-sectional view showing a photoresist film formed on the entire major surface of the glass plate;

FIG. 12B is an enlarged cross-sectional view showing a portion of the photoresist film;

FIG. 13A is a cross-sectional view showing a resist pattern formed on a portion of the major surface of the glass plate after exposing and developing the photoresist film;

FIG. 13B is an enlarged cross-sectional view showing a portion of the resist pattern;

FIG. 14A is a cross-sectional view showing a first metal layer formed on the major surface of the glass plate by Ni electroforming;

FIG. 14B is an enlarged cross-sectional view showing a portion of the first metal layer;

FIG. 15A is a cross-sectional view showing an original stamper isolated from the glass plate;

FIG. 15B is an enlarged cross-sectional view showing a portion of the original stamper;

FIG. 16A is a cross-sectional view showing a second metal layer formed on a major surface of the original stamper by Ni electroforming;

FIG. 16B is an enlarged cross-sectional view showing a portion of the second metal layer;

FIG. 17A is a cross-sectional view showing a second-generation stamper isolated from the original stamper;

FIG. 17B is an enlarged cross-sectional view showing a portion of the second-generation stamper;

FIG. 18 is a cross-sectional view showing a third-generation stamper produced using the second generation stamper by Ni electroforming; and

FIG. 19 is a cross-sectional view showing a fourth-generation stamper produced using the third-generation stamper by Ni electroforming.

### DESCRIPTION OF THE PREFERRED EMBODIMENTS

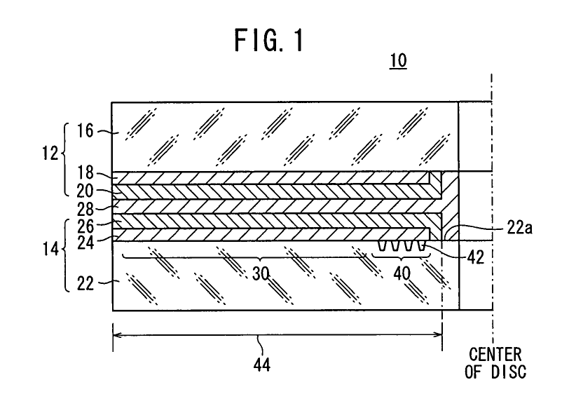

An embodiment of the original glass plate, the original glass plate producing method, the stamper, and the stamper producing method according to the present invention will be described below with reference to FIGS. 1 to 19.

An optical recording medium 10 according to this embodiment is such that information can be recorded thereon by irradiating one surface with a laser light, and a desired visible image can be recorded thereon by irradiating the other surface with the laser light. Thus, in this optical recording medium, at least an information recording layer and an image recording layer are formed in this order on a first substrate, and a second substrate is placed on the image recording layer. A third substrate may be disposed between the information recording layer and the image recording layer.

In the optical recording medium, a surface of the second substrate facing the image recording layer is partly roughened. The roughened portion of a major surface of the second substrate may be referred to as “the roughened substrate surface” in the following description. The roughened substrate surface is formed by transferring a roughened pattern on a stamper onto the major surface of the second substrate as hereinafter described.

The optical recording medium may have a structure of a DVD such as a DVD-R, an HD-DVD, etc. The structure is such a bonded structure that the first substrate having the information recording layer is attached to the second substrate having the image recording layer by an adhesion layer.

Further, the optical recording medium of the embodiment may have a structure of Blu-ray Disc (BD).

A specific structure example of the optical recording medium 10 according to this embodiment will be described below with reference to FIGS. 1 to 3.

The optical recording medium 10 shown in FIG. 1 has a first stack 12 and a second stack 14. The first stack 12 contains a transparent first substrate 16, an information recording layer 18 formed on the first substrate 16, and a first reflective layer 20 formed on the information recording layer 18. The second stack 14 contains a transparent second substrate 22, an image recording layer 24 formed on the second substrate 22, and a second reflective layer 26 formed on the image recording layer 24. The first stack 12 is attached to the second stack 14 by an adhesion layer 28, and the first reflective layer 20 faces the second reflective layer 26.

For example, data (pit information) can be recorded on and/or reproduced from the information recording layer 18 by irradiating the layer with a laser light through the first substrate 16.

For example, a visible image can be recorded on the image recording layer 24 by irradiating the layer with a laser light through the second substrate 22.

In the optical recording medium 10, a roughened substrate surface 30 is formed on a portion of the major surface 22a of the second substrate 22 facing the image recording layer 24. The surface roughness of the roughened substrate surface 30 of the second substrate 22 is preferably such that the arithmetic average roughness Ra is 0.05 to 0.3 μm and the ten-point average roughness Rz is 0.1 to 5 μm. The image visibility of the optical recording medium 10 is largely improved when the roughened substrate surface 30 has such a surface roughness. The values of Ra and Rz of the roughened substrate surface 30 on the second substrate 22 can be measured by an atomic force microscope (AFM), an optical interference-type roughness meter, a stylus-type roughness meter, or the like. The stylus-type roughness meter is particularly preferred because it has a long scanning length and a large dynamic range in the depth direction. Thus, the values of Ra and Rz are obtained by the stylus-type roughness meter in the present invention.

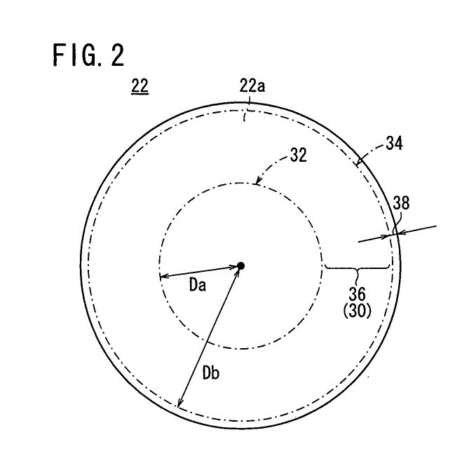

Though the roughened substrate surface 30 may be formed over the entire major surface 22a of the second substrate 22, it is preferably formed in the following area. As shown in FIG. 2, the major surface 22a of the second substrate 22 contains a circular 1st area 32 within a radius Da from the center of the second substrate 22, a circular 2nd area 34 within a radius Db from the center, a ring-shaped 3rd area 36 provided by omitting the 1st area 32 from the 2nd area 34, and a ring-shaped 4th area 38 provided by omitting the 2nd area 34 from the entire major surface 22a of the second substrate 22. The 3rd area 36 is the roughened substrate surface 30, and the radius Da is preferably within a range of 20 mm<Da<25 mm, more preferably within a range of 24 mm<Da<25 mm. When the optical recording medium 10 has a diameter of 80 mm, the radius Db is preferably within a range of 38 mm<Db<40 mm, more preferably within a range of 39 mm<Db<40 mm. When the optical recording medium 10 has a diameter of 120 mm, the radius Db is preferably within a range of 58 mm<Db<60 mm, more preferably within a range of 59 mm<Db<60 mm.

When the roughened substrate surface 30 is formed in a region of less than 20 mm from the center, the visibility is seldom improved by the roughened substrate surface 30 because an optical pickup is hardly placed in the region. On the other hand, when the roughened substrate surface 30 is formed on a region up to the outer circumference edge of the second substrate 22, it becomes difficult to wash the edge of the image recording layer 24.

In the optical recording medium 10, as shown in FIG. 1, there is a pre-pit region 40 on a portion of the 1st area 32 of the second substrate 22. One or more pre-pits 42, preferably a plurality of pre-pits 42, are formed in the pre-pit region 40.

The combination of the pre-pits 42 may provide various information of the optical recording medium 10 such as information for distinguishing the presence of the image recording layer 24, information of output or a spot diameter of a laser light for forming a visible image on the image recording layer 24, or information of tone of a visible image.

Thus, by detecting the pre-pits 42, the presence of the image recording layer 24 in the optical recording medium 10 can be easily detected, and a visible image can be recorded on the image recording layer 24 under an optimum laser output with excellent imaging properties. Further, the combination of the pre-pits 42 may provide manufacturer information etc.

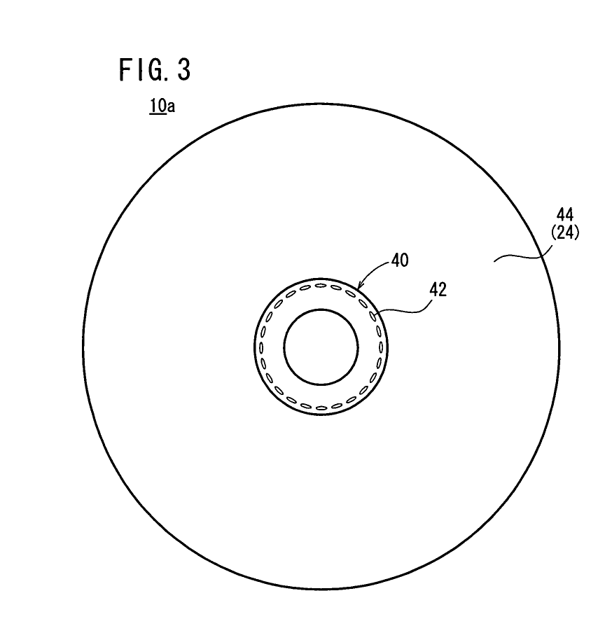

The position of the pre-pit region 40 on the 1st area 32 of the second substrate 22 is not particularly limited. For example, as shown in FIG. 3, the pre-pit region 40 may be formed inside a region having the image recording layer 24 (an imaging region 44) in an optical recording medium 10a of a modification example. In this case, the pre-pits 42 are not filled with a dye compound, so that a light returned from the pre-pits 42 is easily detected advantageously. It should be noted that, to prevent the image recording layer 24 from being formed in the pre-pit region 46, it is necessary to form a certain margin between the outer circumference of the pre-pit region 40 and the inner circumference of the imaging region 44.

As shown in FIG. 1, the pre-pit region 40 may be partly overlapped with the imaging region 44 to make the imaging region 44 as large as possible. Thus, a portion of the image recording layer 24 may be formed on a part of the pre-pits 42.

In the case of forming the pre-pit region 40 on an inner portion of the second substrate 22 as shown in FIGS. 1 to 3, the pre-pit region 40 is preferably in a region of 21 to 24 mm in the radius direction from the center of the second substrate 22.

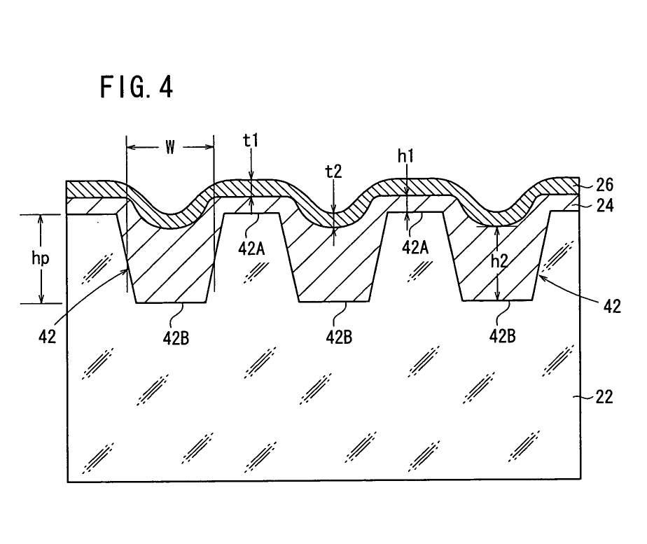

The average of the depths hp of the pre-pits 42, shown in FIG. 4, is 150 to 400 nm, preferably 200 to 300 nm. When the average depth is 150 to 400 nm, a light returned from the pre-pits 42 can be converted to an electronic signal (a returned light signal) having a large signal amplitude, whereby the accuracy of reading the returned light signal can be improved. Further, when the average depth is 200 to 300 nm, the returned light signal can be detected more accurately.

The average of the widths W (the half widths, which are widths at half the depths hp) of the pre-pits 42 in the radius direction is preferably 200 to 500 nm, more preferably 250 to 450 nm. When the average width is 200 to 500 nm, the inter-track crosstalk superposed with the returned light signal is reduced, whereby a signal amplitude sufficient for detection can be obtained. The lengths (the half widths) of the pre-pits 42 in the circumferential direction are appropriately controlled depending on information to be recorded.

The ratio h1/h2, in which h1 represents an average thickness of the image recording layer 24 on the convex portions 42A of the pre-pits 42, and h2 represents an average thickness of the image recording layer 24 on the concave portions 42B, is preferably 0.1 to 0.9. The depth hp+h1−h2 of depression of the image recording layer 24 on the concave portions 42B is preferably 70 to 250 nm.

When the ratio h1/h2 and the depth hp+h1−h2 are within the above ranges, a surface of the image recording layer 24, on which the second reflective layer 26 is formed, has an appropriate convexes and concaves suitable for reading a laser light, so that an excellent reproduced signal can be obtained. The ratio h1/h2 is more preferably 0.2 to 0.8, and the depth hp+h1−h2 is more preferably 100 to 200 nm, further preferably 120 to 180 nm.

The second reflective layer 26 is preferably formed along the image recording layer 24 as shown in FIG. 4. The ratio t1/t2, in which t1 represents an average thickness of the second reflective layer 26 on the convex portions 42A, and t2 represents an average thickness of the second reflective layer 26 on the concave portions 42B, is preferably 0.8 to 1.2, more preferably 0.9 to 1.1.

The above values of hp, h1, h2, etc. can be obtained by an AFM, a transmission spectrum, or an ellipsometer. Further, the values can be obtained by observing a cross-section of the produced optical recording medium 10 using an SEM, etc.

### Stamper and Method of Producing the Same:

The above second substrate 22, which has the pre-pits 42 and the roughened substrate surface 30 on a portion of the major surface 22a, can be produced by using a master stamper 46 according to the present embodiment.

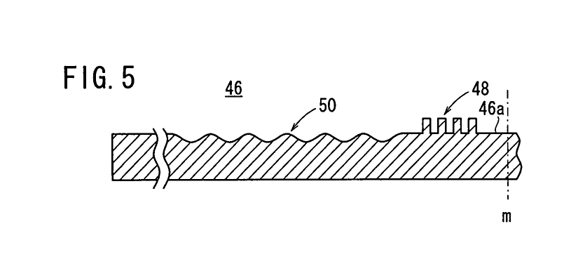

As shown in FIG. 5, in the master stamper 46, a pit forming site 48 for forming the pre-pits 42 on an inner portion of the major surface 22a of the second substrate 22 is formed in a portion of a major surface 46a, and a roughened stamper surface 50 for forming the roughened substrate surface 30 on the second substrate 22 is formed in a portion of the major surface 46a other than the portion on which the pre-pits 42 are formed.

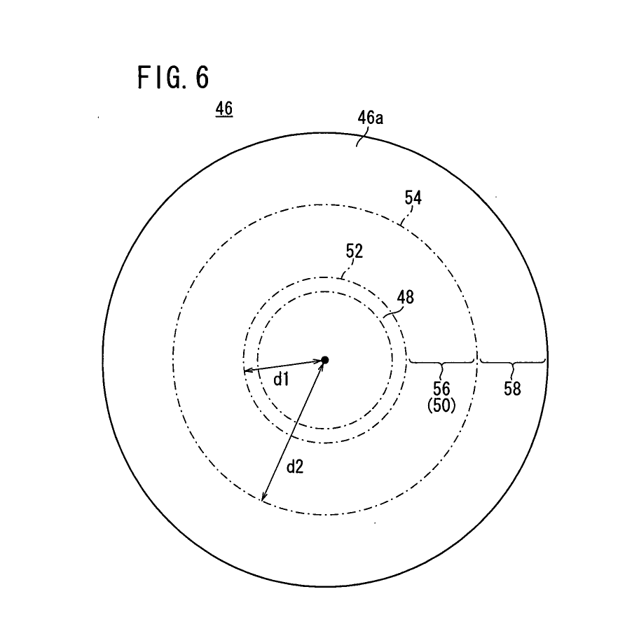

Thus, as shown in FIG. 6, the major surface 46a of the master stamper 46 contains a circular 11th area 52 within a radius d1 from the center of the master stamper 46, a circular 12th area 54 within a radius d2 (>d1) from the center, a ring-shaped 13th area 56 provided by omitting the 11th area 52 from the 12th area 54, and a ring-shaped 14th area 58 provided by omitting the 12th area 54 from the entire major surface 46a of the master stamper 46. In this case, the 13th area 56 between the 11th area 52 and the 14th area 58 is the roughened stamper surface 50, and the pit forming site 48 is formed on a portion of the 11th area 52.

The surface roughness of the 13th area 56 is such that the ten-point average roughness Rz is 0.1 to 5.0 μm and the mean spacing of profile irregularities RSm is 10 to 500 μm. The values of Rz and RSm of the roughened stamper surface 50 on the master stamper 46 can be measured by an atomic force microscope (AFM), an optical interference-type roughness meter, a stylus-type roughness meter, or the like.

The pit forming site 48 contains concave portions and convex portions, and the average height of the convex portions is preferably 150 to 400 nm. The optical recording medium 10 can be efficiently produced by using the master stamper 46.

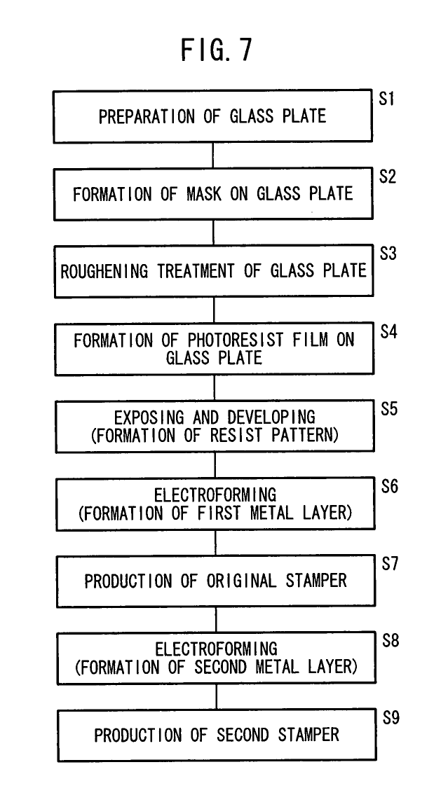

The method of the present invention for producing the master stamper 46 will be described below with reference to FIGS. 7 to 19.

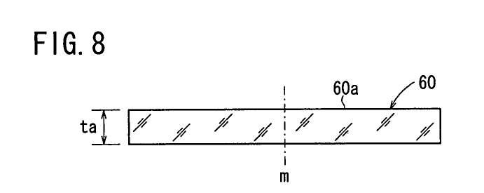

First, an original glass plate 60 is prepared as shown in step S1 of FIG. 7 and FIG. 8. In the original glass plate 60, at least a major surface 60a is lustrous. The thickness ta of the original glass plate 60 is preferably 50 to 65 mm in view of the roughening treatment to be hereinafter described. The dashed-dotted line m represents a center line.

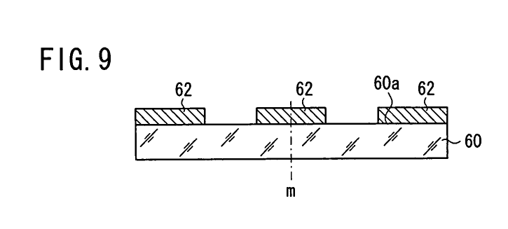

Then, as shown in step S2 of FIG. 7 and FIG. 9, masks 62 are formed on portions of the major surface 60a of the original glass plate 60 to protect the portions against the roughening treatment. The masks 62 may comprise a metal plate, an oxide film, or the like.

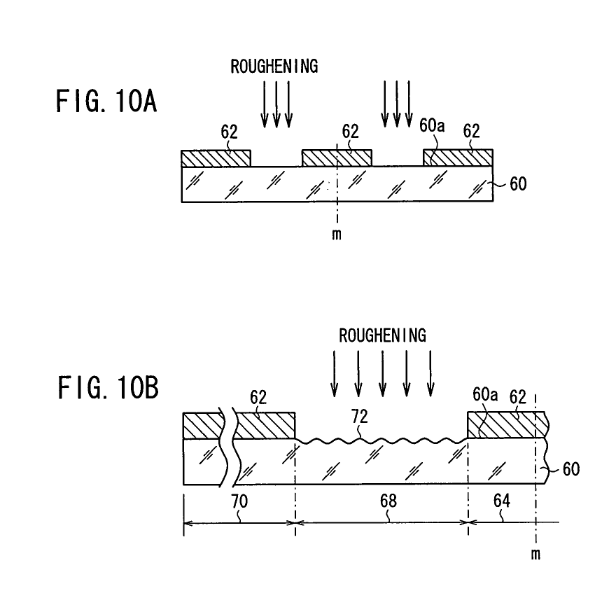

As shown in step S3 of FIG. 7, and FIGS. 10A and 10B, portions on the major surface 60a, exposed between the masks 62, are subjected to the roughening treatment.

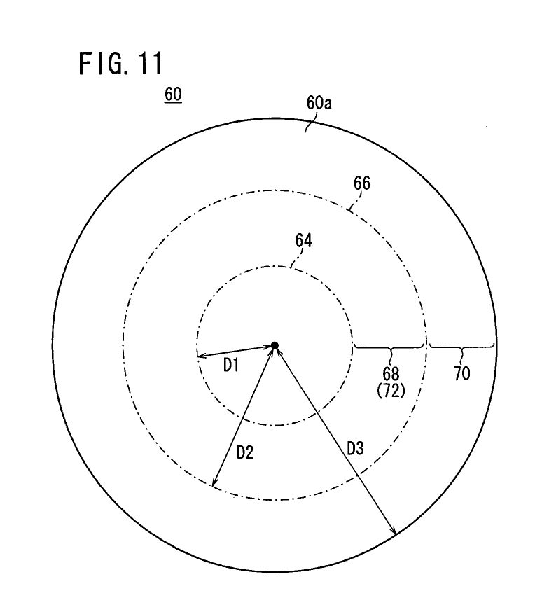

The area to be roughened, in the major surface 60a of the original glass plate 60, will be described below. As shown in FIG. 11, the major surface 60a contains a circular 21st area 64 within a radius D1 from the center of the original glass plate 60, a circular 22nd area 66 within a radius D2 (>D1) from the center, a ring-shaped 23rd area 68 provided by omitting the 21st area 64 from the 22nd area 66, and a ring-shaped 24th area 70 provided by omitting the 22nd area 66 from the entire major surface 60a of the original glass plate 60. In this case, the masks 62 are formed on the 21st area 64 and the 24th area 70, and the 23rd area 68 exposed is roughened. Thus, after the roughening treatment, the 21st area 64 and the 24th area 70 are lustrous while the 23rd area 68 has a roughened glass plate surface 72.

The surface roughness of the roughened glass plate surface 72 in the 23rd area 68 is preferably such that the arithmetic average roughness Ra is 0.05 to 2.0 μm and the ten-point average roughness Rz is 0.1 to 5.0 μm. The values of Ra and Rz of the roughened glass plate surface 72 on the original glass plate 60 can be measured by an atomic force microscope (AFM), an optical interference-type roughness meter, a stylus-type roughness meter, or the like.

When the original glass plate 60 having such a surface roughness is used for preparing the master stamper 46, the second substrate 22 produced by using the master stamper 46 has a surface roughness suitable for improving the image visibility. Thus, the surface roughness of the roughened substrate surface 30 in the produced second substrate 22 is such that the ten-point average roughness Rz is 0.1 to 5.0 μm and the mean spacing of profile irregularities RSm is 10 to 500 μm.

The radius D1 of the 21st area 64 is preferably within a range of 20 mm<D1<25 mm, more preferably within a range of 24 mm<D1<25 mm, as with the radius Da of the 1st area 32 in the second substrate 22. When the optical recording medium 10 has a diameter of 80 mm, the radius D2 of the 22nd area 66 is preferably within a range of 38 mm<D2<40 mm, more preferably within a range of 39 mm<D2<40 mm, as with the radius Db of the 2nd area 34 in the second substrate 22. When the optical recording medium 10 has a diameter of 120 mm, the radius D2 is preferably within a range of 58 mm<D2<60 mm, more preferably within a range of 59 mm<D2<60 mm. The radius D3 of the original glass plate 60 is preferably within a range of 100 mm<D3<125 mm.

Examples of the roughening treatment for the 23rd area 68 of the original glass plate 60 include blasting treatments, grinding treatments, shot-peening treatments, and etching treatments.

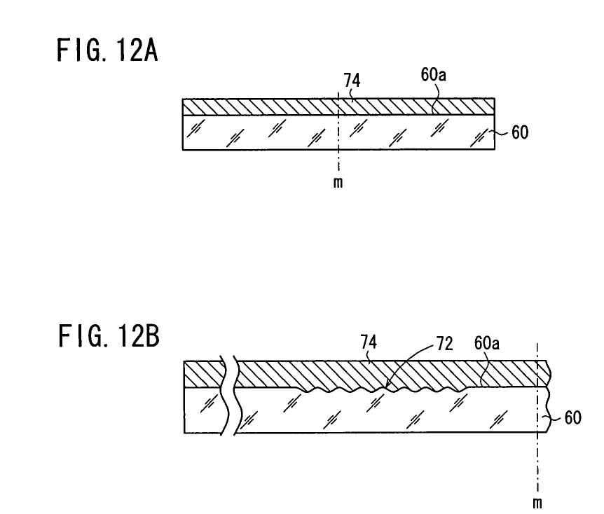

Then, as shown in step S4 of FIG. 7, and FIGS. 12A and 12B, after the masks 62 are removed from the original glass plate 60, a photoresist film 74 is formed over the entire major surface 60a of the glass plate 60.

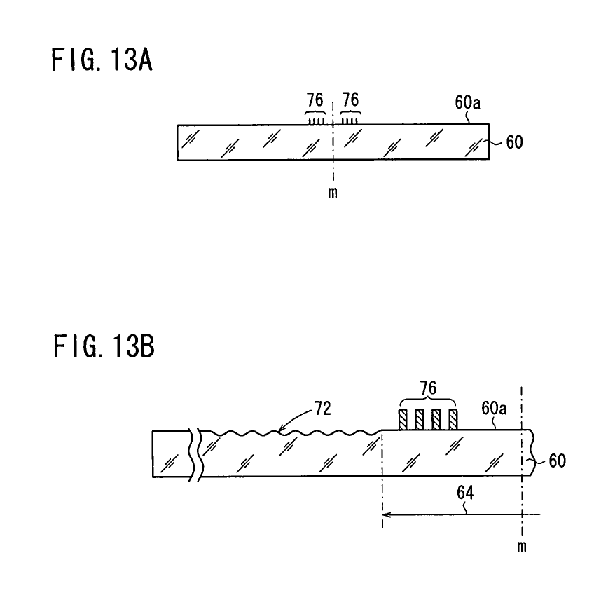

As shown in step S5 of FIG. 7, and FIGS. 13A and 13B, the photoresist film 74 is irradiated with a laser light and developed, whereby a resist pattern 76 for forming the pit forming site 48 is formed on portions of the 21st area 64.

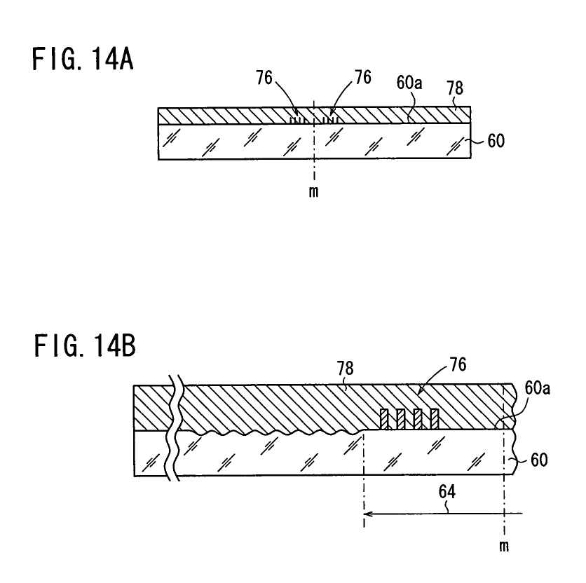

As shown in step S6 of FIG. 7, and FIGS. 14A and 14B, a thin conductive layer (not shown) such as an Ni (nickel) conductive layer is formed on the entire major surface 60a having the resist pattern 76, and a first metal layer 78 (an Ni layer) is formed thereon by Ni electroforming. In addition to the above Ni, Cu (copper), Al (aluminum), Ni alloys, Cu alloys, Al alloys, etc. may be used for the first metal layer 78.

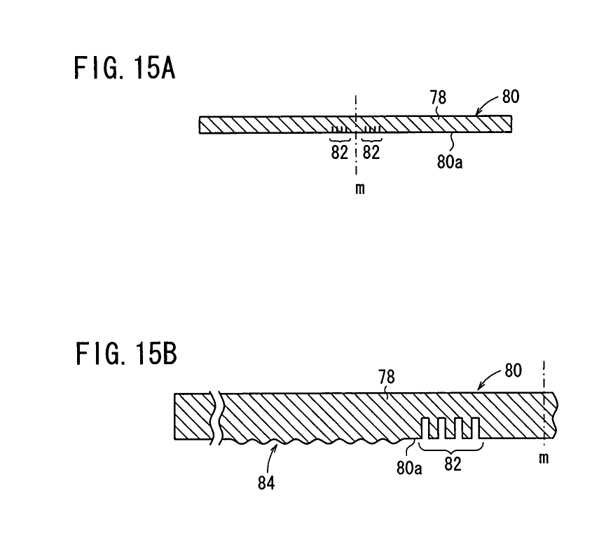

As shown in step S7 of FIG. 7, and FIGS. 15A and 15B, the original glass plate 60 having the resist pattern 76 is removed to obtain an original stamper 80 composed of the first metal layer 78. A major surface 80a of the original stamper 80 contains a first pit forming site 82, which has a transfer pattern of the resist pattern 76 formed on the 21st area 64 of the original glass plate 60 shown in FIG. 13B. Further, the major surface 80a contains a first roughened surface 84, which has a transfer pattern of the roughened glass plate surface 72 formed on the 23rd area 68 of the original glass plate 60 shown in FIG. 13B.

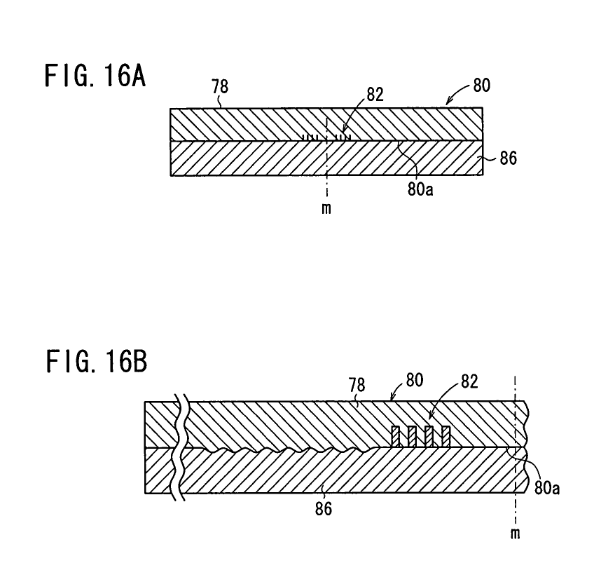

As shown in step S8 of FIG. 7, and FIGS. 16A and 16B, a second metal layer 86 is formed on the major surface 80a of the original stamper 80 by Ni electroforming.

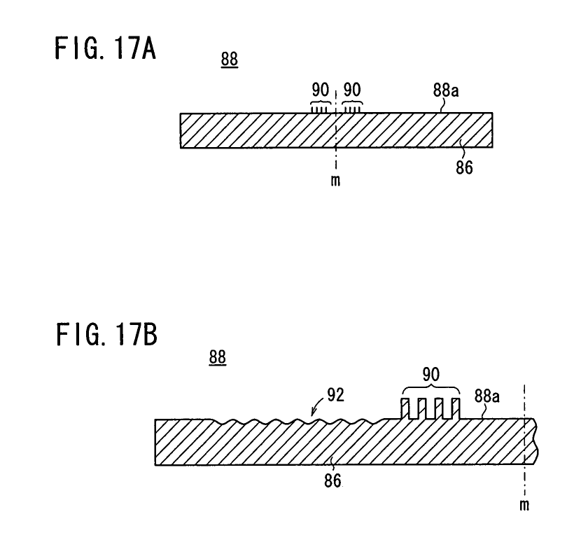

As shown in step S9 of FIG. 7, and FIGS. 17A and 17B, the second metal layer 86 is isolated from the major surface 80a of the original stamper 80 to obtain a metal second-generation stamper 88 composed of the second metal layer 86. A major surface 88a of the second-generation stamper 88 contains a second pit forming site 90, which has a transfer pattern of the first pit forming site 82 formed on the major surface 80a of the original stamper 80 shown in FIG. 15B. Further, the major surface 88a contains a second roughened surface 92, which has a transfer pattern of the first roughened surface 84 formed on the major surface 80a of the original stamper 80 shown in FIG. 15B.

A plurality of the second-generation stampers 88 can be produced using the original stamper 80 by repeating steps S8 and S9 of FIG. 7.

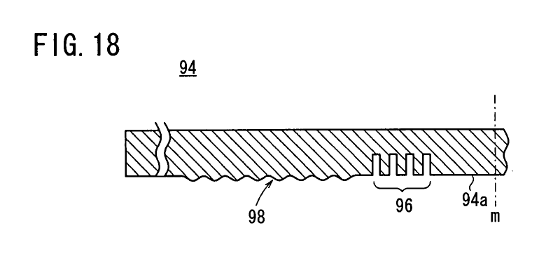

The second-generation stamper 88 may be used as the master stamper 46 for producing the above second substrate 22, and a third-generation stamper 94 shown in FIG. 18 may be produced using the second-generation stamper 88 by Ni electroforming and may be used as the master stamper 46. In this case, a major surface 94a of the third-generation stamper 94 contains a third pit forming site 96, which has a transfer pattern of the second pit forming site 90 on the major surface 88a of the second-generation stamper 88 shown in FIG. 17B. Further, the major surface 94a contains a third roughened surface 98, which has a transfer pattern of the second roughened surface 92 on the major surface 88a of the second-generation stamper 88 shown in FIG. 17B.

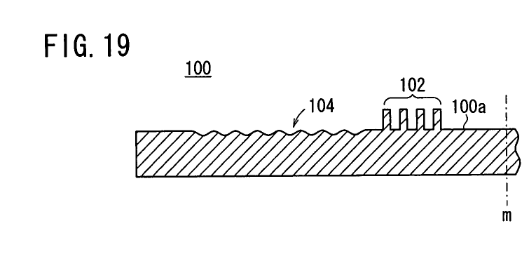

Further, a fourth-generation stamper 100 shown in FIG. 19 may be produced using the third-generation stamper 94 by Ni electroforming and may be used as the master stamper 46. In this case, a major surface 100a of the fourth-generation stamper 100 contains a fourth pit forming site 102, which has a transfer pattern of the third pit forming site 96 on the major surface 94a of the third-generation stamper 94 shown in FIG. 18. Further, the major surface 100a contains a fourth roughened surface 104, which has a transfer pattern of the third roughened surface 98 on the major surface 94a of the third-generation stamper 94 shown in FIG. 18. An example of the fourth stamper 100 used as the master stamper 46 is shown in FIG. 5. Thus, the fourth pit forming site 102 of FIG. 19 corresponds to the pit forming site 48 of FIG. 5, and the fourth roughened surface 104 of FIG. 19 corresponds to the roughened stamper surface 50 of FIG. 5.

The third-generation stamper 94 and the fourth-generation stamper 100 can be repeatedly produced by the Ni electroforming using the second-generation stamper 88 and the third-generation stamper 94 respectively. Thus, a large number of the master stampers 46 can be more easily produced with lower production costs and higher productivity in the case of using the third-generation or fourth-generation stampers, as compared with the case of using the second-generation stamper 88 as the master stamper 46.

As described above, the glass plate 60 of this embodiment has the ring-shaped, roughened 23rd area 68 between the 21st area 64 and the 24th area 70 as shown in FIG. 11. The master stamper 46 can be produced by a method according to the present embodiment using the glass plate 60, and the optical recording medium 10 excellent in the visibility of an image on the label surface can be produced by using the produced master stamper 46.

The structure of the optical recording medium 10 is not particularly limited as long as it contains the pre-pit region 40 with the one or more pre-pits 42 and the image recording layer 24 on which a visible image can be formed by irradiation of a laser light. Thus, the optical recording medium 10 may be a read-only-, WORM (Write Once, Read Many)- or rewritable-type medium, and is preferably a WORM-type medium. The recording manner of the optical recording medium 10 may be selected from phase change-, magnetic optical-, and dye-type recording manners without particular restrictions, and is preferably dye-type.

The optical recording medium 10 shown in FIG. 1 is such that the first substrate 16 having the information recording layer 18 is attached to the second substrate 22 having the image recording layer 24. Thus, the optical recording medium 10 is preferably used for DVDs such as DVD-Rs, DVD-RWs, and HD-DVDs.

Examples of the layer structure of the optical recording medium 10 include the following first to sixth unillustrated layer structures in addition to the above structure shown in FIG. 1.

(1) The first layer structure is such that the information recording layer 18, the first reflective layer 20, and the adhesion layer 28 are formed in this order on the first substrate 16, and the second substrate 22 having the image recording layer 24 is attached to the adhesion layer 28.

(2) The second layer structure is such that the information recording layer 18, the first reflective layer 20, a protective layer, and the adhesion layer 28 are formed in this order on the first substrate 16, and the second substrate 22 having the image recording layer 24 is attached to the adhesion layer 28.

(3) The third layer structure is such that the information recording layer 18, the first reflective layer 20, a first protective layer, the adhesion layer 28, and a second protective layer are formed in this order on the first substrate 16, and the second substrate 22 having the image recording layer 24 is attached to the second protective layer.

(4) The fourth layer structure is such that the information recording layer 18, the first reflective layer 20, a first protective layer, the adhesion layer 28, a second protective layer, and a third protective layer are formed in this order on the first substrate 16, and the second substrate 22 having the image recording layer 24 is attached to the third protective layer.

(5) The fifth layer structure is substantially equal to the structure of FIG. 1, and is such that the information recording layer 18, the first reflective layer 20, the adhesion layer 28, and the second reflective layer 26 are formed in this order on the first substrate 16, and the second substrate 22 having the image recording layer 24 is attached to the second reflective layer 26.

(6) The sixth layer structure is such that the information recording layer 18, the first reflective layer 20, and a first protective layer are formed in this order on the first substrate 16, the image recording layer 24, the second reflective layer 26, and a second protective layer are formed in this order on the second substrate 22, and the first protective layer is attached to the second protective layer by the adhesion layer 28.

The layer structure of FIG. 1 and the first to sixth layer structures are considered in all respects to be illustrative and not restrictive, and the above layers may be formed in another order and the layers other than the image recording layer 24 may be omitted. Further, each of the layers may have a single- or multi-layer structure.

When an optical information is recorded on or reproduced from the optical recording medium 10, the first substrate 16 side of the optical recording medium 10 is irradiated with a laser light having a predetermined wavelength, which may be 650 to 670 nm for DVD-Rs and 400 to 410 nm or less for HD-DVDs.

When a visible image is recorded on the image recording layer 24, the second substrate 22 side of the optical recording medium 10 is irradiated with a laser light (such as a laser light having a linear speed of 3.5 m/s, a wavelength of 660 nm, an NA value of 0.6, and a medium surface power of 10 mW), and the irradiated portions are degenerated to change the contrast, which results in visibility of the image.

In the present invention, the desired image can be efficiently recorded on the label surface (the image recording surface) of the optical recording medium 10 by the laser light using an optical recording medium drive without a printer or the like. Further, the surface of the second substrate 22, facing the image recording layer 24, is roughened, whereby the visibility of the image can be improved.

In this embodiment, the first substrate 16 is disposed on one side of the information recording layer 18, etc., and the second substrate 22 is disposed on the other side. The second substrate 22 may have a cover layer, a transparent sheet, or the like. Thus, the optical recording medium 10 of this embodiment may have a structure of CDs such as CD-Rs, in which an information recording layer, an image recording layer, and a cover layer are formed in this order on a substrate.

In the CD-type structure, the information recording layer 18, the first reflective layer 20, a protective layer, the second reflective layer 26, and the image recording layer 24 are formed in this order on the first substrate 16, and a roughened cover layer is formed on the image recording layer 24. In this structure, the surface of the cover layer, facing the image recording layer 24, is roughened, whereby the image visibility can be improved.

In this case, when an optical information is recorded or reproduced on the CD-type optical recording medium 10, the first substrate 16 side of the optical recording medium 10 is irradiated with a laser light having a predetermined wavelength of 660 nm, etc.

When a visible image is recorded on the image recording layer 24, the cover layer side (the second substrate 22 side) of the CD-type optical recording medium 10 is irradiated with a laser light, and the irradiated portions are degenerated to change the contrast as a visible image.

Thus, even when the optical recording medium has the CD-type structure, an image can be formed thereon by a laser light. The desired image can be efficiently recorded on the label surface (the image recording surface) of the optical recording medium 10 by using an optical recording medium drive without a printer or the like. Further, the surface of the second substrate 22, facing the image recording layer 24, is roughened, whereby the visibility of the image can be improved.

The optical recording medium 10 having the DVD-type structure shown in FIG. 1 may be produced in the following manner. Thus, for example, the master stamper 46 having the roughened stamper surface 50 on one major surface is prepared using the glass plate 60 of this embodiment, the second substrate 22 having the roughened substrate surface 30 on one major surface is prepared using the master stamper 46, the image recording layer 24 is formed on the second substrate 22, the information recording layer 18 is formed on the first substrate 16, and the first substrate 16 and the second substrate 22 are bonded such that the information recording layer 18 and the image recording layer 24 face each other, whereby the optical recording medium 10 can be produced.

A reflective layer or a protective layer may be formed in the step of forming the information recording layer and the step of image recording layer if necessary.

The optical recording medium having the CD-type structure can be produced by forming at least the information recording layer 18, the image recording layer 24, and the cover layer (the second substrate 22) having a roughened surface on the first substrate 16.

The layer structure of FIG. 1 and the first to sixth layer structures are considered in all respects to be illustrative and not restrictive, and the above layers may be formed in another order and the layers other than the image recording layer 24 may be removed. Further, each of the layers may have a single- or multi-layer structure.

The layers and forming methods thereof will be described below with reference to the layer structure of the optical recording medium 10 shown in FIG. 1.

### (Information Recording Layer 18)

The information recording layer 18 is a layer on which information, particularly code information such as digital information, is recorded and reproduced by a laser light. The information recording layer 18 may be a dye recording layer or a phase change recording layer, and is preferably a dye recording layer.

Examples of dyes used in the information recording layer 18 include cyanine dyes, oxonol dyes, azo dyes, phthalocyanine dyes, triazole compounds such as benzotriazole compounds, triazine compounds, merocyanine compounds, aminobutadiene compounds, cinnamic acid compounds, benzoxazole compounds, pyrromethene compounds, and squarylium compounds. The dyes may have a metal atom as a coordination center.

Dyes described in Japanese Laid-Open Patent Publication Nos. 4-74690, 8-127174, 11-53758, 11-334204, 11-334205, 11-334206, 11-334207, 2000-43423, 2000-108513, and 2000-158818 may be used in the present invention.

When the optical recording medium is CD-R, preferred ones among the above are the cyanine dyes, azo dyes, and phthalocyanine dyes. When the optical recording medium is a DVD-R, preferred ones are the cyanine dyes, oxonol dyes, azo dyes (including Ni complexes and Co complexes), and pyrromethene compounds. When the optical recording medium is a Blu-ray disc or an HD-DVD, preferred ones are the cyanine dyes, oxonol dyes, azo dyes, phthalocyanine dyes, benzotriazole compounds, and triazine compounds.

Further, the cyanine dyes, azo dyes, and phthalocyanine dyes are more preferred in the case of the CD-R, the cyanine dyes, oxonol dyes, and azo dyes (including Ni complexes and Co complexes) are more preferred in the case of the DVD-R, and the cyanine dyes, oxonol dyes, azo dyes, and phthalocyanine dyes are more preferred in the case of the Blu-ray disc or HD-DVD.

The information recording layer 18 may be formed by the steps of dissolving a binder, etc. and a recording substance such as the dye in an appropriate solvent to prepare a coating liquid, applying the coating liquid to the first substrate 16, and drying the applied liquid. The concentration of the recording substance in the coating liquid is generally 0.01% to 15% by mass, preferably 0.1% to 10% by mass, more preferably 0.5% to 5% by mass, most preferably 0.5% to 3% by mass.

The information recording layer 18 may be formed by vapor deposition, sputtering, CVD, or liquid coating, and is preferably formed by liquid coating. In the case of the liquid coating, a quencher, a binder, or the like is dissolved in the solvent together with the dye, etc. if necessary, and the obtained coating liquid is applied to the substrate and dried.

Examples of the solvents for the coating liquid include esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, isopropanol, n-butanol, and diacetone alcohol; fluorine-containing solvents such as 2,2,3,3-tetrafluoropropanol; and glycol ethers such as ethylene glycol monomethyl ether, ethylene glycol monoethyl ether, and propylene glycol monomethyl ether.

These solvents may be used singly or in combination depending on the solubility of the dye. Various additives such as antioxidants, UV absorbers, plasticizers, and lubricants may be added to the coating liquid if necessary.

Examples of the binders include natural organic high-molecular substances such as gelatins, cellulose derivatives, dextrans, rosins, and rubbers, and synthetic organic high-molecular substances. The synthetic organic high-molecular substances include hydrocarbon resins such as polyethylenes, polypropylenes, polystyrenes, and polyisobutylenes; vinyl resins such as polyvinyl chlorides, polyvinylidene chlorides, and vinyl chloride-vinyl acetate copolymers; acrylic resins such as polymethyl acrylates and polymethyl methacrylates; and initial condensation products of thermosetting resins such as polyvinyl alcohols, chlorinated polyethylenes, epoxy resins, butyral resins, rubber derivatives, and phenol-formaldehyde resins.

In the case of using the binder in the information recording layer 18, the mass of the binder is generally 0.01 to 50 times the dye, preferably 0.1 to 5 times the dye.

The coating liquid may be applied by a spraying method, a spin coating method, a dipping method, a roll coating method, a blade coating method, a doctor roll method, a screen printing method, etc. The information recording layer may have a single- or multi-layer structure. The thickness of the information recording layer is generally 10 to 500 nm, preferably 15 to 300 nm, more preferably 20 to 150 nm.

An anti-fading agent may be added to the information recording layer 18 to increase the light fastness. In general, the anti-fading agent is a singlet oxygen quencher. The singlet oxygen quencher may be selected from those described in known publications such as patent publications. Specific examples of the singlet oxygen quenchers include those described in Japanese Laid-Open Patent Publication Nos. 58-175693, 59-31194, 60-18387, 60-19586, 60-19587, 60-35054, 60-36190, 60-36191, 60-44554, 60-44555, 60-44389, 60-44390, 60-54892, 60-47069, 63-209995, and 4-25492, Japanese Patent Publication Nos. 1-38680 and 6-26028, Germany Patent No. 350399, Nippon Kagakukaishi, 1992, October issue, Page 1141, etc.

The ratio of the anti-fading agent such as the singlet oxygen quencher to the dye is generally 0.1% to 50% by mass, preferably 0.5% to 45% by mass, further preferably 3% to 40% by mass, particularly preferably 5% to 25% by mass.

In a case where the information recording layer 18 is a phase change-type recording layer, it is preferred that the layer comprises a phase change-type optical recording material containing Ag, Al, In, Te, or Sb, which can be converted to at least two stages of the crystalline state and the amorphous state. Specific examples of such optical recording materials include Sb—Te alloys, Ge—Sb—Te alloys, Pd—Ge—Sb—Te alloys, Nb—Ge—Sb—Te alloys, Pd—Nb—Ge—Sb—Te alloys, Pt—Ge—Sb—Te alloys, Co—Ge—Sb—Te alloys, In—Sb—Te alloys, Ag—In—Sb—Te alloys, Ag—V—In—Sb—Te alloys, and Ag—Ge—In—Sb—Te alloys. Among them, Ge—Sb—Te alloys and Ag—In—Sb—Te alloys are capable of rewriting many times, and thus are preferably used. The thickness of the phase change-type information recording layer 18 is preferably 10 to 50 nm, more preferably 15 to 30 nm.

The phase change-type information recording layer 18 may be formed by a gas-phase film deposition method such as a sputtering method or a vacuum vapor deposition method. A known dielectric layer may be formed on the information recording layer 18 if necessary.

### (Image Recording Layer 24)

As described above, the optical recording medium 10 contains the image recording layer 24, which is closer to the second substrate 22 (or the cover layer) than the information recording layer 18. A desired visible image (a visible information) such as a character, figure, or picture is recorded on the image recording layer 24. The visible image is an image that can be visually detected, and may contain any visible information such as a character (text), picture, or figure.

The visible image recorded on the image recording layer 24 may contain a desired image such as a character, figure, or picture. Specifically, the visible image may contain a disc title, content information, a thumbnail of contents, a related picture, a design picture, a copyright notice, a recording date, a recording method, a recording format, a bar code, etc.

Further, the visible image may contain character information such as accessible personal information, accessible period information, accessible number information, rental information, resolution information, layer information, user designation information, copyright holder information, copyright number information, manufacturer information, manufacturing date information, sale date information, vendor or seller information, set number information, regional designation information, language designation information, use designation information, user information, or use number information.

The image recording layer 24 is not particularly limited as long as a visible image such as a character, image, or picture can be recorded thereon by irradiation of a laser light. It is preferred that the image recording layer 24 contains a dye compound from the viewpoint of forming a clear visible image by the irradiation of a laser light. The dye compound for the image recording layer 24 is preferably selected from the above described examples of the dyes for the information recording layer 18. It is preferred from the viewpoint of costs that the image recording layer 24 is formed by applying a coating liquid containing the dye compound by spin coating.

In the optical recording medium 10, the component (the dye or the phase change recording material) of the information recording layer 18 may be the same as or different from the component of the image recording layer 24. Because the desired functions are different between the information recording layer 18 and the image recording layer 24, the components thereof are preferably different. Specifically, it is preferred that the information recording layer 18 comprises a component excellent in recording/reproducing properties, and the image recording layer 24 comprises a component capable of forming a high-contrast image. In the case of using the dye, it is particularly preferred that the image recording layer 24 comprises a cyanine dye, a phthalocyanine dye, an azo dye, an azo metal complex, or an oxonol dye from the viewpoint of increasing the contrast of the recorded image.

The image recording layer 24 may comprise a leuco dye. Specifically, preferred examples of the leuco dyes include crystal violet lactones; phthalide compounds such as 3,3-bis(1-ethyl-2-methylindol-3-yl)phthalide and 3-(4-diethylamino-2-ethoxyphenyl)-3-(1-ethyl-2-methylindol-3-yl)-4-azaphthalide; and fluoran compounds such as 3-cyclohexylmethylamino-6-methyl-7-anilinofluoran, 2-(2-chloroanilino)-6-dibutylaminofluoran, 3-diethylamino-6-methyl-7-anilinofluoran, 3-diethylamino-6-methyl-7-xylidinofluoran, 2-(2-chloroanilino)-6-diethylaminofluoran, 2-anilino-3-methyl-6(N-ethylisopentylamino)fluoran, 3-diethylamino-6-chloro-7-anilinofluoran, 3-benzylethylamino-6-methyl-7-anilinofluoran, and 3-methylpropylamino-6-methyl-7-anilinofluoran.

The image recording layer 24 may be formed by dissolving the dye in a solvent to prepare a coating liquid, and by applying the coating liquid. The solvent may be the same as that of the coating liquid for the information recording layer 18. Additives and application methods for the image recording layer 24 are the same as those for the information recording layer.

The thickness of the image recording layer 24 is preferably 0.01 to 50 μm, more preferably 0.02 to 20 μm, further preferably 0.03 to 5 μm.

It is preferred that the visible information is recorded on the image recording layer 24 by repeatedly moving a laser light having a predetermined power in approximately the same trajectory. Further, it is preferred that the laser light having a predetermined power is oscillated in the radius direction of the optical recording medium and moved in approximately the same trajectory.

### (First Substrate 16)

The first substrate 16 may comprise a material selected from materials used in conventional optical recording medium substrates.

Examples of the materials for the first substrate 16 include glasses, polycarbonates, acrylic resins such as polymethyl methacrylates, vinyl chloride resins such as polyvinyl chlorides and vinyl chloride copolymers, epoxy resins, amorphous polyolefins, and polyesters. These materials may be used in combination. The materials may be used in the state of a film or a rigid substrate as the first substrate 16. Among the materials, polycarbonates are preferred from the viewpoints of humidity resistance, dimensional stability, and cost.

The thickness of the first substrate 16 is preferably 0.05 to 1.2 mm, more preferably 0.1 to 1.1 mm.

Guide grooves for tracking or concavities (pregrooves) with information of address signal, etc. are formed in the first substrate 16.

In a case where the optical recording medium is a DVD-R or DVD-RW, the track pitch of the pregrooves is preferably 300 to 900 nm, more preferably 350 to 850 nm, further preferably 400 to 800 nm.

The depth (the groove depth) of each pregroove is preferably 100 to 160 nm, more preferably 120 to 150 nm, further preferably 130 to 140 nm. The groove width (the half width) of each pregroove is preferably 200 to 400 nm, more preferably 230 to 380 nm, further preferably 250 to 350 nm.

The first substrate 16 may have grooves with a track pitch smaller than those of conventional DVD-Rs, to achieve a higher recording density. In this case, the track pitch of the grooves is preferably 280 to 450 nm, more preferably 300 to 420 nm, further preferably 320 to 400 nm. The depth (the groove depth) of each groove is preferably 15 to 150 nm, more preferably 25 to 100 nm. The groove width of each groove is preferably 50 to 250 nm, more preferably 100 to 200 nm.

In a case where the optical recording medium is CD-R, the track pitch of the grooves is preferably 1.2 to 2.0 μm, more preferably 1.4 to 1.8 μm, further preferably 1.55 to 1.65 μm. The depth (the groove depth) of each groove is preferably 100 to 250 nm, more preferably 150 to 230 nm, further preferably 170 to 210 nm. The groove width of each pregroove is preferably 400 to 650 nm, more preferably 480 to 600 nm, further preferably 500 to 580 nm.

An undercoat layer may be formed on the grooved surface of the first substrate 16, on which the information recording layer 18 is formed, to improve flatness and adhesion and to prevent deterioration of the recording layer.

Examples of materials of the undercoat layer include polymers such as polymethyl methacrylates, acrylic acid-methacrylic acid copolymers, styrene-maleic anhydride copolymers, polyvinyl alcohols, N-methylolacrylamide, styrene-vinyltoluene copolymers, chlorosulfonated polyethylenes, nitrocelluloses, polyvinyl chlorides, chlorinated polyolefins, polyesters, polyimides, vinyl acetate-vinyl chloride copolymers, ethylene-vinyl acetate copolymers, polyethylenes, polypropylenes, and polycarbonates, and surface modifying agents such as silane coupling agents. The undercoat layer may be formed by dissolving or dispersing the material in an appropriate solvent, and by applying thus-obtained coating liquid to the substrate by a coating method such as spin coating, dip coating, or extrusion coating. The thickness of the undercoat layer is generally 0.005 to 20 μm, preferably 0.01 to 10 μm.

### (First Reflective Layer 20 and Second Reflective Layer 26)

The first reflective layer 20 and the second reflective layer 26 are preferably formed on the information recording layer 18 and the image recording layer 24 to increase the reflectance to the laser light for information reproduction. The first reflective layer 20 and the second reflective layer 26 preferably comprise a light reflective substance having a high reflectance to the laser light. Examples of the light reflective substances include metals of Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, Bi, etc., metalloids, stainless steels, and semiconductor materials. These substances may be used singly or in combination, or as an alloy.

Among them, the light reflective substance is preferably Cr, Ni, Pt, Cu, Ag, Au, Al, or a stainless steel, particularly preferably Au, Ag, Al, or an alloy thereof, most preferably an Ag alloy such as an Ag—Nd—Cu alloy or an Ag—Pd—Cu alloy.

For example, the first reflective layer 20 and the second reflective layer 26 can be formed on the information recording layer 18 and the second substrate 22 by vapor-depositing, sputtering, or ion-plating the light reflective substance. The thickness of each of the first reflective layer 20 and the second reflective layer 26 is generally 10 to 300 nm, preferably 50 to 200 nm.

### (Adhesion Layer 28)

The adhesion layer 28 is formed to bond the first stack 12 containing the first substrate 16 to the second stack 14 containing the second substrate 22 in production of a bond type optical recording medium such as a DVD. The adhesion layer 28 is preferably composed of a light curing resin. It is preferred that the light curing resin has a small cure shrinkage ratio from the viewpoint of preventing warping of the resultant disc. Examples of such light curing resins include SD-640 and SD-661 available from Dainippon Ink and Chemicals, Inc., and SK6100, SK6300, and SK6400 available from Sony Chemical Corporation. The thickness of the adhesion layer 28 is preferably 1 to 100 μm, more preferably 5 to 60 μm, particularly preferably 20 to 55 μm, in view of flexibility.

### (Protective Layer, not Shown)

The protective layer is optionally formed to prevent penetration of water and scratching. The protective layer preferably comprises a UV curing resin, a visible light curing resin, a thermosetting resin, or silicon dioxide, particularly preferably comprises a UV curing resin. For example, SD-640 available from Dainippon Ink and Chemicals, Inc. can be used as the UV curing resin. Further, SD-347 and SD-694 available from Dainippon Ink and Chemicals, Inc., and SKCD1051 available from SKC can be used in the protective layer. The thickness of protective layer is preferably 1 to 200 μm, more preferably 50 to 150 μm.

### (Second Substrate 22)

The step of roughening the second substrate 22 is described in detail above, and thus duplicate explanations therefor are omitted.

The second substrate 22 having the roughened substrate surface 30 faces the first substrate 16 in the bond type optical recording medium 10. The second substrate 22 may comprise the same material as the first substrate 16. It is not necessary to form a groove on the surface of the second substrate 22, on which the image recording layer 24 is formed, as with the first substrate 16. The thickness of the second substrate 22 is preferably 0.05 to 1.2 mm, more preferably 0.1 to 1.1 mm, further preferably 0.5 to 0.7 mm.

In a case where the second substrate 22 is the cover layer, generally the cover layer is formed to physically and chemically protect the information recording layer 18, the image recording layer 24, etc. In this embodiment, the cover layer on the image recording layer 24 is roughened to increase the image visibility. The cover layer preferably has a thickness of 10 nm to 5 μm.

A transparent sheet of a polycarbonate or cellulose triacetate may be used as the cover layer. In this case, the transparent sheet preferably has a thickness of 0.01 to 0.2 mm. It is preferred that a surface of the transparent sheet, facing the image recording layer, is roughened by the above mentioned stamper.

As described above, at least the image recording layer 24 and the information recording layer 18 are formed in this order on one surface of the roughened second substrate 22 in the optical recording medium 10.

The second substrate 22 can be used in an optical member having an image recording layer 24 on which an image is formed by a light, other than the optical recording medium 10. Thus, in the optical member, at least the image recording layer is formed on the roughened surface of the substrate. Examples of such optical members include stickers.

In the optical recording medium 10 of this embodiment, an intermediate layer adjacent to the second substrate 22 may have a roughened surface facing the image recording layer 24. When the intermediate layer has the roughened surface facing the image recording layer 24, it is not necessary to form the roughened substrate surface 30 on the second substrate 22. The intermediate layer may be the protective layer, which may comprise a UV curing resin.

### Recording Method:

Specifically, an image is recorded on the image recording layer 24 in the optical recording medium 10 of the embodiment by using at least a recording apparatus capable of recording an image information.

In this embodiment, by using only one optical recording medium drive (a recording apparatus), image information can be recorded on the image recording layer 24 and optical information can be recorded on the information recording layer 18. In the case of using the only one optical recording medium drive, for example, information is recorded on one of the image recording layer 24 and the information recording layer 18, the optical recording medium 10 is reversed, and then another information is recorded on the other layer. Examples of such optical recording medium drives having a function of recording a visible image on an image recording layer are described in Japanese Laid-Open Patent Publication Nos. 2002-203321, 2003-203348, and 2003-242750, etc.

In this embodiment, by detecting the pre-pits 42, the presence of the image recording layer 24 in the optical recording medium 10 can be easily detected. Further, based on the information of the pre-pits 42, a visible image can be recorded on the image recording layer 24 under an optimum laser output with excellent imaging properties.

It should be noted that the original glass plate, the original glass plate producing method, the stamper, and the stamper producing method according to the present invention are not limited to the above embodiment, and various changes and modifications may be made therein without departing from the scope of the present invention.

What is claimed is:

1. A disc-shaped original glass plate for producing a stamper for roughening a substrate of an optical recording medium, comprising
a circular first area within a radius D1 from the center of said original glass plate,
a circular second area within a radius D2 (>D1) from the center,
a ring-shaped third area obtained by omitting said first area from said second area, and
a ring-shaped fourth area obtained by omitting said second area from an entire surface of said original glass plate, wherein
said first area and said fourth area are lustrous, and said third area is roughened.

2. An original glass plate according to claim 1, wherein said third area has an arithmetic average roughness Ra of 0.05 to 2.0 μm in a surface roughness thereof.

3. An original glass plate according to claim 1, wherein said third area has a ten-point average roughness Rz of 0.1 to 5.0 μm in a surface roughness thereof.

4. An original glass plate according to claim 1, wherein said radius D2 of said second area is equal to or smaller than the radius of said substrate.

5. An original glass plate according to claim 1, wherein said first area is used for forming a pit forming site on said stamper, and said pit forming site is used for forming a pre-pit on an inner portion of said substrate.

6. An original glass plate according to claim 1, wherein said third area is roughened by a blasting treatment, a grinding treatment, a shot-peening treatment, or an etching treatment.

7. An original glass plate according to claim 1, wherein said original glass plate has a thickness of 50 to 65 mm.

8. A method of producing a disc-shaped original glass plate for producing a stamper for roughening a substrate of an optical recording medium, comprising the steps of:
preparing a disc-shaped glass plate having at least a lustrous major surface comprising a circular first area within a radius D1 from the center of said glass plate, a circular second area within a radius D2 (>D1) from the center, a ring-shaped third area obtained by omitting said first area from said second area, and a ring-shaped fourth area obtained by omitting said second area from the entire major surface;
masking said first area and said fourth area; and
roughening said unmasked third area in said major surface of said glass plate to obtain said original glass plate.

9. A method according to claim 8, wherein said unmasked third area is roughened by a blasting treatment, a grinding treatment, a shot-peening treatment, or an etching treatment.

10. A stamper for roughening a substrate of an optical recording medium, comprising
a circular first area within a radius D1 from the center of said stamper,
a circular second area within a radius D2 (>D1) from the center,
a ring-shaped third area obtained by omitting said first area from said second area, and
a ring-shaped fourth area obtained by omitting said second area from an entire surface of said stamper, wherein
said first area and said fourth area are lustrous, and said third area is roughened.

11. A stamper according to claim 10, wherein said third area has a ten-point average roughness Rz of 0.1 to 5.0 μm in a surface roughness thereof.

12. A stamper according to claim 10, wherein said third area has a mean spacing of profile irregularities RSm of 10 to 500 μm in a surface roughness thereof.

13. A stamper according to claim 10, wherein said radius D2 of said second area is equal to or smaller than the radius of said substrate.

14. A stamper according to claim 10, wherein said first area has a pit forming site for forming a pre-pit on an inner portion of said substrate.

15. A stamper according to claim 10, wherein said stamper has a thickness of 140 to 300 μm.

16. A method of producing a stamper for roughening a substrate of an optical recording medium, comprising the steps of:
preparing a disc-shaped original glass plate having at least a lustrous major surface comprising a circular first area within a radius D1 from the center of said original glass plate, a circular second area within a radius D2 (>D1) from the center, a ring-shaped third area obtained by omitting said first area from said second area, and a ring-shaped fourth area obtained by omitting said second area from the entire major surface;
masking said first area and said fourth area;
roughening said unmasked third area in said major surface of said original glass plate; and
forming a metal layer on said major surface of said original glass plate to obtain an original stamper,
whereby in said stamper for roughening said substrate of said optical recording medium, an area corresponding to said third area of said original glass plate is roughened.

17. A method according to claim 16, further comprising the step of forming a resist mask on said first area of said original glass plate after the step of roughening said third area before the step of forming said metal layer, wherein said resist mask is used for forming a pit forming site for forming a pre-pit on said optical recording medium, whereby in said stamper for roughening said substrate of said optical recording medium, an area corresponding to said first area of said original glass plate has said pit forming site, and an area corresponding to said third area of said original glass plate is roughened.
